(19) United States
(12) Patent Application Publication
(10) Pub. No.: US 2017/0199599 A1
(43) Pub. Date: Jul. 13, 2017

(54) CAPACITIVE TOUCH PANEL

(71) Applicant: Kaneka Corporation, Osaka (JP)

(72) Inventors: Yuji Takahashi, Osaka (JP); Hitoshi Tamai, Osaka (JP)

(73) Assignee: Kaneka Corporation, Osaka (JP)

(21) Appl. No.: 15/472,846

(22) Filed: Mar. 29, 2017

Related U.S. Application Data
(63) Continuation of application No. PCT/JP2015/075337, filed on Sep. 7, 2015.

(30) Foreign Application Priority Data
Sep. 30, 2014 (JP) 2014-200462

(51) Int. Cl. G06F 3/044

(52) U.S. Cl. CPC G06F 3/044

(57) ABSTRACT

Provided is a capacitive touch panel having increased sensitivity for non-contact operation, while maintaining high resolution for contact operation. This capacitive touch panel (1) comprises one or more transparent film substrates (2, 5), multiple first-direction electrodes (X) arranged on the film substrates (2, 5) and extending in a first direction (the left/right direction), and multiple second-direction electrodes (Y) arranged on the film substrates and extending in a second direction (the up/down direction) intersecting the first direction. This capacitive touch panel is characterized in that each of the first-direction electrodes (X) and the second-direction electrodes (Y) comprise multiple fine wires (30, 40) of a conductive material, and that at least one transparent electrically conducting film electrode (6) is provided for detecting non-contact operation.

### CROSS-REFERENCE TO RELATED APPLICATIONS

The present application is a continuation of International Application No. PCT/JP2015/075337 filed Sep. 7, 2015, published on Apr. 7, 2016, which claims priority from Japanese Patent Application No. 2014-200462 filed Sep. 30, 2014, all of which are incorporated herein by reference.

### TECHNICAL FIELD

The present invention relates to a capacitive touch panel for electronic equipment, and more specifically relates to a dual mode capacitive touch panel having both contact and non-contact detection capabilities. The touch panel can particularly detect not only contact, such as by a person's finger or other object, but also the presence of a finger or other object even without contact when a person's finger comes into a predetermined proximity with the touch panel.

### BACKGROUND ART

In recent years, a touch panel, in which data input and operation commands can be performed by touching a panel surface with a pen tip and/or a fingertip, is widely used as an input device for mobile equipment such as smart phones, tablet devices, and handheld gaming machines. There are various types of touch panels, which differ in terms of structures and methods for detecting contact positions, such as resistive touch panels and capacitive touch panels. In recent years, projected capacitive touch panels with multipoint detection capability have been increasingly popular.

In general, a projected capacitive touch panel includes a supporting substrate such as glass and plastic; a transparent insulating layer; and two transparent electrically conducting film layers on which electrode pattern of multiple lines of X-direction electrodes and multiple columns of Y-direction electrodes are formed with a transparent electrode material such as ITO. The two transparent electrically conducting film layers have the transparent insulating layer therebetween stacked on the supporting substrate, to form matrix-like capacitor elements of the multiple lines and multiple columns. The stray capacitance between a fingertip and a transparent electrode changes when the fingertip approaches the surface of a touch panel. This will be detected to determine the position in the X direction and the Y direction at which the fingertip touches the panel surface.

Here, the transparency of a transparent electrically conducting film layer needs to be improved in order to vividly project a display image on a display device with a touch panel. This in turn requires a technology for reducing the thickness of a transparent electrically conducting film layer such as ITO as thin as possible. However, if a transparent electrically conducting film layer is reduced the thickness, it may increase sheet resistance, resulting in decreased response speed and resolution. In addition, when a touch panel for a large screen is manufactured with a transparent electrically conducting film such as ITO, its electrode pattern is prolonged to increase wiring resistance, resulting in decreased response speed.

Accordingly, Patent Document 1 discloses a capacitive touch panel in which stripe-shaped X-direction electrodes and stripe-shaped Y-direction electrodes are formed with metal (copper) thin wires in place of transparent electrically conducting films such as ITO, which are stacked crosswise to form a mesh-like electrode layer. Metal (copper) has lower resistibility as compared with transparent electrically conducting film materials such as ITO, thus can lower wiring resistance when used for electrode pattern in a capacitive touch panel. It can also be used in a touch panel for a large screen.

Meanwhile, a majority of current capacitive touch panels detect contact by a fingertip and/or a pen tip with a panel surface. However, touching the panel surface with a fingertip may leave fingerprints thereon, resulting in a decreased display visibility. Further, an impact due to a contact with a fingertip and/or a pen tip may reduce the durability of the touch panel. Moreover, a contact-type touch panel may not be operable with a dirty finger. For these reasons, there are increasing demands for a touch panel capable of detecting not only contact operations but also non-contact operations as touch panels becomes more popular.

Patent Document 2 discloses an OLED interface capable of detecting both contact and non-contact. In this OLED interface, a panel layer GL, an anode electrode layer A, an organic luminescent layer O, and a cathode electrode layer K are layered in this order, and a transparent electrode layer is formed on a surface of the panel layer GL by the ITO coating method so that multiple rhombus electrode segments 2 form a matrix-like arrangement pattern of multiple lines and multiple columns.

Among the electrode segments 2 in this ITO transparent electrode layer, a group of 4 electrodes: electrode columns S1 and S9 and electrode lines Z1 and Z5 located in the edge region is considered as a “frame”, with which an approach of a fingertip can be detected in a non-contact manner to determine the X position and the Y position of the fingertip. The X position of the fingertip is detected with the electrode columns S1 and S9 in a non-contact manner while the Y position of the fingertip is detected with the electrode lines Z1 and Z5 in a non-contact manner. Further, it is configured to be capable of detecting a detection signal for the distance between the panel surface and a fingertip to determine the Z position. When the Z position of the fingertip is below the minimum distance, the mode is changed to the contact mode to allow detecting the X position and the Y position of the fingertip by the contact operation.

Patent Document 1: Japanese Unexamined Patent Application, Publication No. 2014-029614

Patent Document 2: Japanese Unexamined Patent Application, Publication No. 2014-512615

### DISCLOSURE OF THE INVENTION

### Problems to be Solved by the Invention

In the case of a capacitive touch panel, it needs to maintain the resolution high at a certain level in order to allow both contact operations and non-contact operations to be detected in one touch panel. This in turn requires increasing the number of detection electrodes within a limited region. This means that the area per detection electrode will be small, so much so that it cannot detect the amount of change in capacitance values when a fingertip is in close proximity. That is, only contact operations can be detected, but non-contact operations cannot be detected.

The electrode pattern of the transparent electrode layer according to Patent Document 2 is the same as the ITO electrode pattern of the conventional capacitive touch panel, and has a small area per detection electrode. Therefore, capacitance cannot be significantly increased even when multiple detection electrodes are connected to form columns and lines of electrode. As a result, it is difficult to enhance the sensitivity for detecting non-contact operations.

Meanwhile, one possibility to enhance the sensitivity for non-contact operations in a dual mode capacitive touch panel supporting both the contact mode and the non-contact mode is to increase the electrode surface area of an ITO electrode segment to increase capacitance. However, when the electrode surface area of an ITO electrode segment is increased within a limited region, the number of detection electrodes is then decreased, resulting in a reduced resolution for contact operations. For these reasons, it is difficult to obtain a touch panel capable of detecting non-contact operations with high sensitivity while maintaining a high resolution for contact operations at a certain level.

An object of the present invention is to provide a capacitive touch panel having an increased sensitivity for non-contact operations while maintaining a high resolution for contact operations.

### Solution to the Problems

A capacitive touch panel is provided according to the present invention, including: one or more transparent film substrates; multiple first-direction electrodes arranged on the film substrate and extending in a first direction; and multiple second-direction electrodes arranged on the film substrate and extending in a second direction crosswise to the first direction, in which each of the first-direction electrodes and each of the second-direction electrodes include multiple fine wires made of an electrical conducting material, and at least one transparent electrically conducting film electrode for detecting non-contact operation is provided.

The area of the transparent electrically conducting film electrode may be larger than the total area of portions of the multiple first-direction electrodes and the multiple second-direction electrodes overlapping with the transparent electrically conducting film electrode from a top view.

The first- and second-direction electrodes may be intended for detecting contact operation, and the transparent electrically conducting film electrode may include an electrically conducting material different from the first- and second-direction electrodes.

The first direction may be the lateral direction and the second direction may be the longitudinal direction, and the transparent electrically conducting film electrode may include a pair of transparent electrically conducting film electrodes for detecting operation in the first direction aligned along the first direction, and a pair of transparent electrically conducting film electrodes for detecting operation in the second direction aligned along the second direction.

Further, the transparent electrically conducting film electrode may include a pair of transparent electrically conducting film electrodes for detecting operation in a third direction aligned along the third direction where the first direction is rotated in the clockwise direction for 45°, and a pair of transparent electrically conducting film electrodes for detecting operation in a fourth direction aligned along the fourth direction where the second direction is rotated in the clockwise direction for 45°.

Further, the multiple first-direction electrodes and the multiple second-direction electrodes may be formed on a first surface of a film substrate, and the transparent electrically conducting film electrode may be formed on a second surface of the film substrate. The transparent electrically conducting film electrode may be formed on the first surface of the film substrate, and the multiple first-direction electrodes and the multiple second-direction electrodes having an insulating layer therebetween may be formed on a surface of that transparent electrically conducting film electrode.

Further, it may be configured such that two of the multiple first-direction electrodes, the multiple second-direction electrodes, and the transparent electrically conducting film electrode may be formed on a first film substrate to obtain a first film member, the remaining one of the multiple first-direction electrodes, the multiple second-direction electrodes, and the transparent electrically conducting film electrode may be formed on a second film substrate to obtain a second film member, and the first film member and the second film member may be bonded through an adhesive layer.

Moreover, it may be configured such that the multiple first-direction electrodes may be formed on the first surface of the first film substrate, and the multiple second-direction electrodes may be formed on the second surface to obtain a first film member; and the transparent electrically conducting film electrode may be formed on the first surface and/or the second surface of the second film substrate to obtain a second film member; and the first film member may be arranged at a position closer to the panel surface than the second film member.

### Effects of the Invention

According to the present invention, X positions and Y positions of contact operation can be detected with high precision by virtue of the multiple first-direction electrodes and the multiple second-direction electrodes. Further, since the at least one transparent electrically conducting film electrode is larger than the total area of overlapping portions of the multiple first-direction electrodes and the multiple second-direction electrodes from a top view, it enables to enhance the sensitivity for non-contact. That is, it enables one capacitive touch panel to achieve highly sensitive detection of non-contact operation, while enhancing resolution capability for contact operation. Non-contact detection is understood to occur when an object, such as a finger or a stylus or the like, is detected within a predetermined proximity of a panel prior to physical contact with the panel.

### BRIEF DESCRIPTION OF THE DRAWINGS

FIG. 1 shows a top view of a capacitive touch panel according to Example 1 of the present invention.

FIG. 2 shows an exploded perspective view of Example 1.

FIG. 3 shows a top view of a first-direction electrode layer according to Example 1.

FIG. 4 shows a top view of a second-direction electrode layer according to Example 1.

FIG. 5 shows a general configuration diagram for capacitor elements according to Example 1.

FIG. 6 shows a top view of a transparent electrically conducting film electrode layer according to Example 1.

FIG. 7 shows a cross sectional view illustrating the layer structure of the capacitive touch panel according to Example 1.

FIG. 8 shows a cross sectional view illustrating the layer structure of a capacitive touch panel according to an alternative embodiment.

FIG. 9 shows a cross sectional view illustrating the layer structure of a capacitive touch panel according to an alternative embodiment.

FIG. 10 shows a cross sectional view illustrating the layer structure of a capacitive touch panel according to an alternative embodiment.

FIG. 11 shows a cross sectional view illustrating the layer structure of a capacitive touch panel according to an alternative embodiment.

FIG. 12 shows a top view of a transparent electrically conducting film electrode of a capacitive touch panel according to Example 2.

FIG. 13 shows a top view of a transparent electrically conducting film electrode of a capacitive touch panel according to Example 3.

FIG. 14 shows a top view of a transparent electrically conducting film electrode of a capacitive touch panel according to Example 4.

FIG. 15 shows a top view of a transparent electrically conducting film electrode of a capacitive touch panel according to Example 5.

### PREFERRED EMBODIMENT FOR CARRYING OUT THE INVENTION

Below, preferred embodiments of the present invention are described based on Examples.

### Example 1

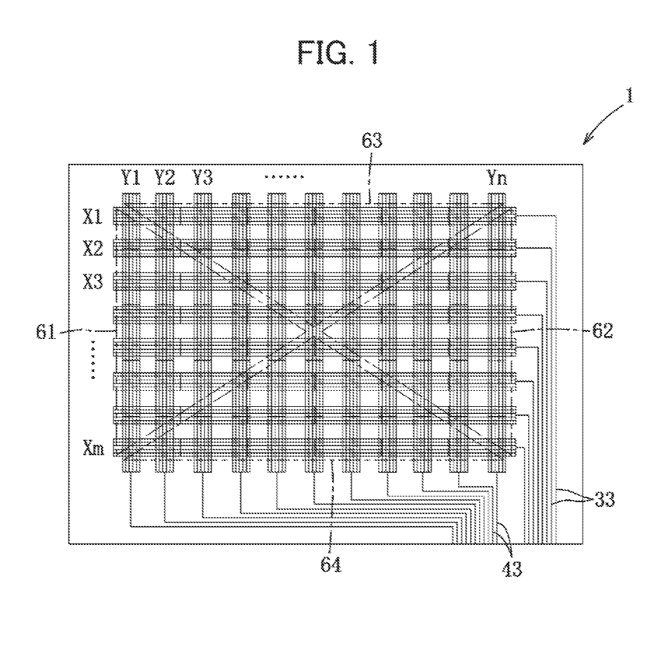

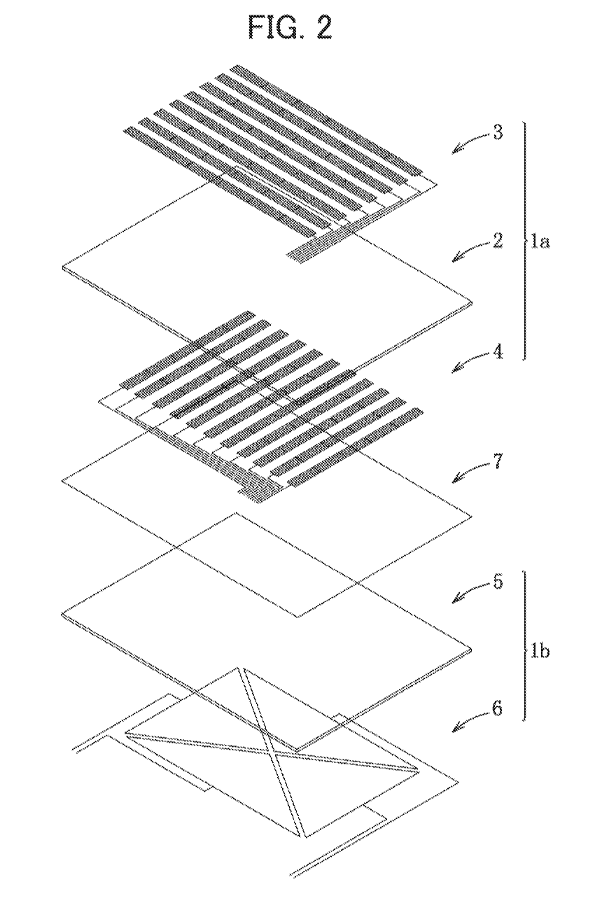

FIGS. 1 and 2 shows the general configuration of a capacitive touch panel 1 according to this Example. The capacitive touch panel 1 has the following configuration: a first-direction electrode layer 3 and a second-direction electrode layer 4 are formed on a front surface (a first surface) and a back surface (a second surface) of a transparent film substrate 2 respectively to obtain a first film member 1a; a transparent electrically conducting film electrode layer 6 is formed on a back surface of a transparent film substrate 5 to obtain a second film member 1b; and the first film member 1a is bonded with the second film member 1b through a transparent adhesive layer 7.

There is no particular limitation for a material of the transparent film substrates 2, 5, as long as it is clear and transparent at least in the visible light region, and has thermal resistance at temperature of forming a transparent electrode layer. Materials for the transparent film substrates 2, include: polyester resins such as polyethylene terephthalate (PET), polybutylene terephthalate (PBT), and polyethylene naphthalate (PEN); cycloolefin-based resins; polycarbonate resins; polyimide resin; cellulose-based resins; and the like. In particular, polyethylene terephthalate and cycloolefin-based resins are preferred.

There is no particular limitation for the thickness of the transparent film substrates 2, 5, but it is preferably 10 μm to 400 μm, more preferably 50 μm to 125 μm. When the thickness is within the above ranges, the transparent film substrates 2, 5 may have durability and appropriate flexibility enough for highly productive deposition of the first-direction electrode layer 3 and the second-direction electrode layer 4 on the both surfaces of the transparent film substrate 2, and for highly productive deposition of the transparent electrically conducting film electrode layer 6 on a back surface of the transparent film substrate 5 by the roll-to-roll method.

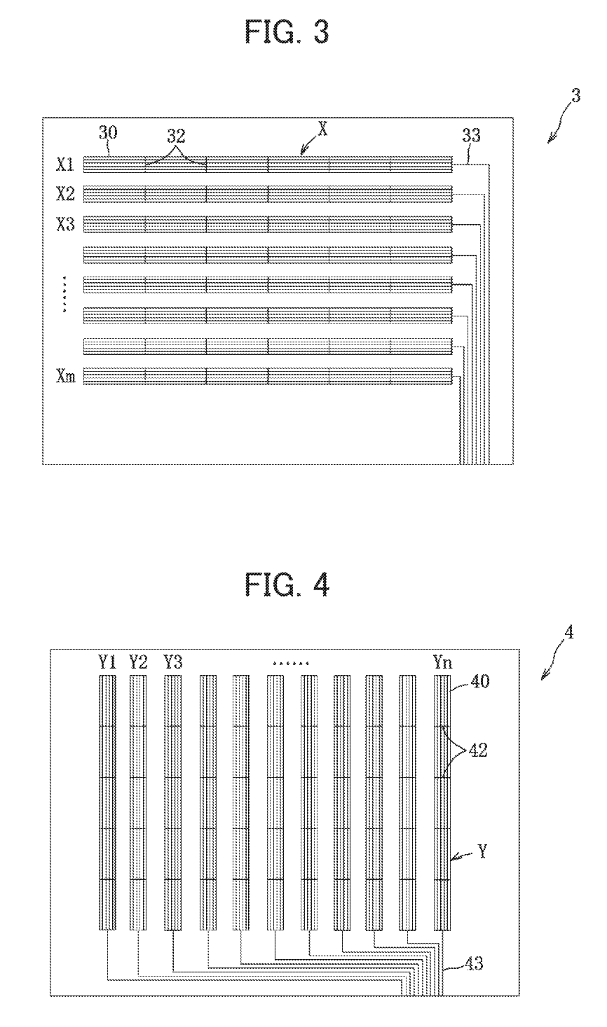

Next, the first-direction electrode layer 3 and the second-direction electrode layer 4 for detecting contact operation are described below based on FIGS. 3 and 4. As shown in FIG. 3, for example, six electrically conducive fine wires 30 extending in the lateral direction (the first direction) arranged in parallel with the same pitch are connected in parallel to form one first-direction electrode X. The first-direction electrode X preferably includes five redundant wires 32 electrically connecting 6 electrically conducting fine wires 30 at, for example, six equally divided positions in the lateral direction. The first-direction electrode layer 3 is formed an electrode pattern, in which m lines of the first-direction electrodes X are aligned in stripes with a pitch of 5 mm to form first-direction electrodes X1 to Xm, having a corresponding connection wire withdrawn from each of the first-direction electrodes X respectively to be assembled in one side.

As shown in FIG. 4, for example, six electrically conducive fine wires 40 extending in the lateral direction (the second direction) arranged in parallel with the same pitch are connected in parallel to form one second-direction electrode Y. The second-direction electrode Y preferably includes four redundant wires 42 electrically connecting six electrically conducting fine wires 40 at, for example, 5 equally divided positions in the longitudinal direction. On the second-direction electrode layer 4, an electrode pattern is formed, in which n columns of the second-direction electrodes Y are aligned in a stripe manner with a pitch of 5 mm to form second-direction electrodes Y1 to Yn, having a corresponding connection wire withdrawn from each of the second-direction electrodes Y respectively to be assembled in one side.

The electrically conducting fine wires 30, 40 each have a thickness of 100 nm to 5 μm, and a line width of 1 μm to 5 μm. Due to such thickness and line width, it may cause breaking during manufacture of the first-direction electrode layer 3 and the second-direction electrode layer 4. Therefore, the redundant wires 32, 42 are provided to prevent such breaking of the first- and second-direction electrodes X, Y.

There is no particular limitation for the material of the electrically conducting fine wires 30, 40 as long as it has electric conductivity, and it can be appropriately selected depending on a purpose. However, it is preferred to use metal fine wires having low electric resistivity and good electric conductivity. It is particularly preferred to use metals such as Ag, Al, Cu, Ni and Au for an electrically conducting material.

The first-direction electrode layer 3 and the second-direction electrode layer 4 of the first film member 1a are deposited by the sputtering method or the electrolytic plating method. Consequently, the transparent film substrate 2 used in this Example was of a sheet-like rectangular form. However, the configuration is not limited to this. Any form can be appropriately selected as long as it can serve as an insulating layer for the first-direction electrode layer 3 and the second-direction electrode layer 4.

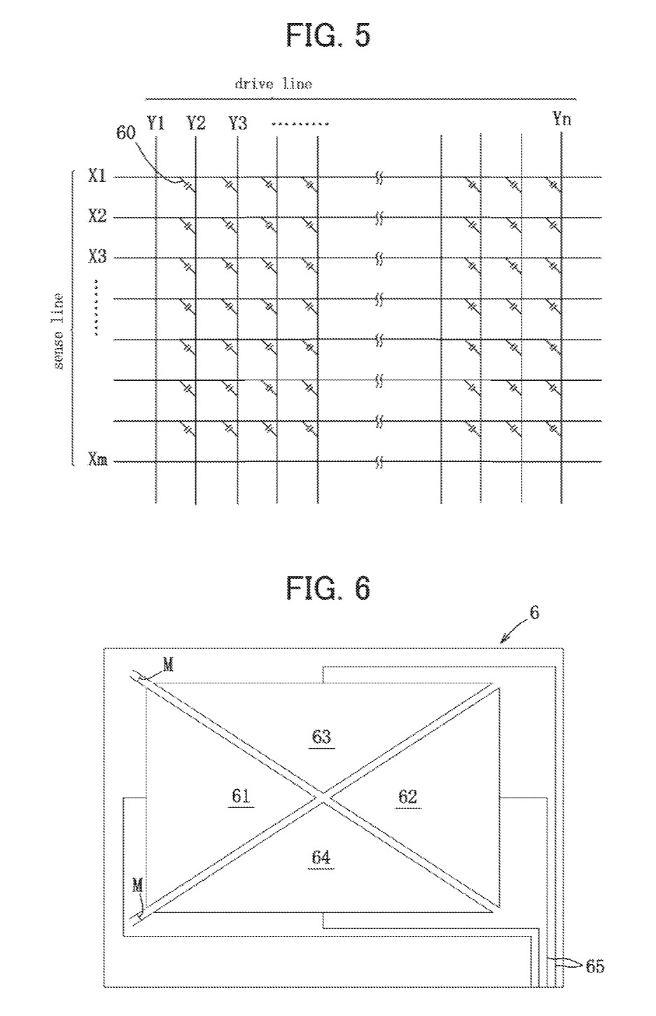

As shown in FIG. 5, the capacitive touch panel 1 includes the n number of drive lines (the second-direction electrodes Y) and the m number of sense lines (the first-direction electrodes X), in which capacitor elements 60 for the capacitance mode are arranged at intersecting points thereof. By providing driving signals sent to the n number of the drive lines Y1 to Yn every very short time, and by reading signals from the m number of sense lines while each of the drive lines Y1 to Yn is driving to detect a signal in the first- and second-directions corresponding to contact operation. When a fingertip of a user contacts the panel surface, stray capacitance is developed between the fingertip and the first- and second-direction electrodes X, Y and affects the quantity of electricity in the capacitor elements 60. This can allow the capacitor elements 60 arranged on the capacitive touch panel 1 to detect contact operation based on signals from the sense lines.

Further, on the first film member 1a in FIGS. 1, 2, electrode pattern is formed in a grid intersecting with a 90° angle by layering the first-direction electrode layer 3 and the second-direction electrode layer 4. However, the electrode pattern formed on the first film member 1a is not limited to such configuration intersecting with a 90° angle.

For example, when the intersecting angles between the first-direction electrodes X1 to Xm of the first-direction electrode layer 3 and the second-direction electrodes Y1 to Yn of the second-direction electrode layer 4 are set to somewhat smaller or larger than 90°, it allows to form electrode pattern in which the first-direction electrode layer 3 and the second-direction electrode layer 4 are layered with an angle somewhat different from 90°. This may prevent from causing interference fringe (moire) possibly developed due to an interaction with electrode lines of a display screen in the back side of a touch panel, and improve visibility.

Next, a transparent electrically conducting film electrode layer 6 for detecting non-contact operation with high sensitivity is described below based on FIGS. 1, 2, and 6. The transparent electrically conducting film electrode layer 6 is formed on the back side of the transparent film substrate 5, on which electrode pattern is formed as shown in FIG. 6. There, a pair of electrode segments 61, 62 for detecting lateral operation aligned along the lateral direction (the first direction) and a pair of electrode segments 63, 64 for detecting longitudinal operation aligned along the longitudinal direction (the second direction) are arranged with an equally separated gap M provided between the electrodes adjacent each other, having a connection wire 65 withdrawn from each of the electrode segments 61 to 64 respectively to be assembled in one side.

The transparent electrically conducting film electrode layer 6 can be made of any transparent electrically conducting material. It is preferably made of an electrically conducting material different from the material of the first-direction electrode layer 3 and the second-direction electrode layer 4, and for example, preferably made of a metal oxide (ITO) or an electrically conductive polymer material. The thickness of the transparent electrically conducting film electrode layer 6 is preferably 100 nm or less, and the gap M is preferably 50 μm to 100 μm. The area of each of the electrode segments 61 to 64 of the transparent electrically conducting film electrode layer 6 is set to be larger than the total area of portions of the multiple first-direction electrodes X and the multiple second-direction electrodes Y overlapping with each of the electrode segments 61 to 64 from a top view.

That the area of each of the electrode segments 61 to 64 being large allows a line of electric force from the transparent electrically conducting film electrode layer 6 to easily escape from the panel surface to the outside, even when the first-direction electrode layer 3 and the second-direction electrode layer 4 for contact operation are arranged above the transparent electrically conducting film electrode layer 6 (closer to the panel surface) as a layer structure. This enables highly sensitive detection of non-contact operation. That is, non-contact operation may be detected with the transparent electrically conducting film electrode layer 6 as follows. Micro currents which flow through the connection wires 65 are continually monitored every very short time. When a user's fingertip approaches the panel surface, the stray capacitance is developed between the electrode segments 61 to 64 at a position of the non-contact operation (a position corresponding to the fingertip) and the fingertip, and then a micro current flows through the electrode segments 61 to 64 at the position of the non-contact operation. This can be, for example, relatively detected to determine the position of the non-contact operation.

Here, the sensitivity for detecting non-contact operation with a capacitive touch panel is related to an electrode surface area. The larger is the electrode surface area, the higher is the sensitivity, enabling high sensibility detection even at a position where a user's fingertip is not in contact with the panel surface. Therefore, in the case of the capacitive touch panel 1, the sensitivity for detecting non-contact operation is related to the area of the electrode segments 61 to 64 of the transparent electrically conducting film electrode layer 6 for detecting non-contact operation. That is, the larger is the area of the electrode segments 61 to 64, the higher is the sensibility, enabling to high sensibility detection even at a position where a fingertip of a user is distant from the panel surface.

Movement of a fingertip from the left to the right in a non-contact state can be detected as the fingertip is close to a panel surface. This occurs as a signal is detected with the electrode segment 61 and then with the electrode segment 62 in the non-contact state. Similarly, a movement of a fingertip from the right to the left in the non-contact state can be detected when a signal is detected with the electrode segment 62 and then with the electrode segment 61. Similarly, a downstroke movement of a fingertip in the non-contact state can be detected when a signal is detected with the electrode segment 63 and then with the electrode segment 64. Similarly, an upstroke movement of a fingertip in the non-contact state can be detected when a signal is detected with the electrode segment 64 and then with the electrode segment 63.

Specific examples of non-contact operation which can be performed with the transparent electrically conducting film electrode layer 6 according to this Example are described below. While a fingertip is kept in a predetermined proximity with the panel surface, as the fingertip moves between the electrode segments 61 and 62, command may be provided, for example, scrolling right-and-left on a display screen, page feeding and returning. Similarly, as a fingertip moves between the electrode segments 63 and 64, command may be provided, for example, scrolling up-and-down on a display screen, turning volume up and down.

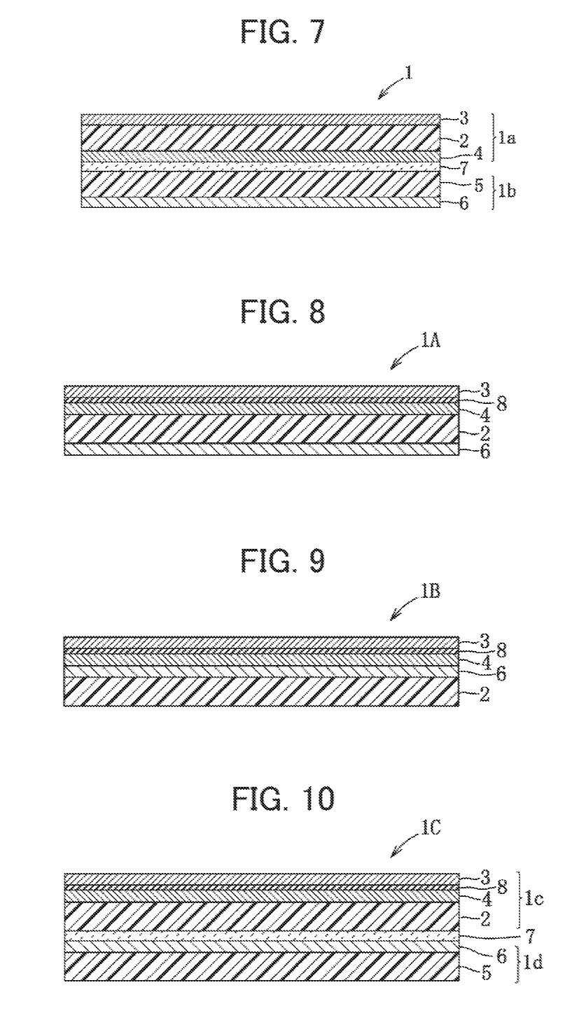

Next, the layer structure of the capacitive touch panel 1 according to Example 1 is described below with reference to FIG. 7. As shown in FIG. 7, the capacitive touch panel 1 may be manufactured by bonding the first film member 1a with the second film member 1b through the transparent adhesive layer 7. The first film member 1a comprises by forming the first-direction electrode layer 3 on the front surface of the transparent film substrate 2, and forming the second-direction electrode layer 4 on the back surface of the transparent film substrate 2. The second film member 1b comprises by forming the transparent electrically conducting film electrode layer 6 on the back surface of the transparent film substrate 5. The transparent adhesive layer 7 may be selected appropriately, as long as it is an optically transparent double-sided adhesive sheet (OCA) having excellent transparency, adhesion reliability, and corrosion resistance against the transparent electrically conducting film.

Next, the steps for producing the capacitive touch panel 1 according to Example 1 are described below with reference to FIG. 7.

The capacitive touch panel 1 may be produced through the following steps in this order: a first step of forming the first-direction electrode layer 3 on the front surface of the transparent film substrate 2; a second step of forming the second-direction electrode layer 4 on the back surface of the transparent film substrate 2; a third step of forming the transparent electrically conducting film electrode layer 6 on the back surface of the transparent film substrate 5; and a fourth step of bonding the first film member 1a with the second film member 1b.

First, the first step of forming the first-direction electrode layer 3 on the front surface of the transparent film substrate 2 is described below. A seed layer is deposited on the front surface of the transparent film substrate 2 with a sputtering apparatus by the roll-to-roll method. Metal, metal oxide, and the like are used as a target to be placed inside a chamber of the sputtering apparatus. Then, patterning of an electrode pattern on the first-direction electrode layer 3 is performed by the photo lithography method.

With regard to patterning, a photoresist agent is applied on a surface of the seed layer, and then irradiated with (exposed to) ultraviolet light over a photomask having electrode pattern of the first-direction electrode layer 3 formed thereon. The photoresist agent is then allowed to react to print the electrode pattern on the seed layer. Subsequently, a metal film (copper) is deposited on portions which are not coated with the resist by the electrolytic plating method, and then the resist is removed. Finally, etching treatment is performed to remove unwanted exposed portions of the seed layer.

Next, the second step of forming the second-direction electrode layer 4 on the back surface of the transparent film substrate 2 is performed as in the first step. Here, a photomask having electrode pattern of the second-direction electrode layer 4 formed thereon is used instead of the electrode pattern of the first-direction electrode layer 3. After the second step is completed, the first film member 1a is obtained in which the first-direction electrode layer 3 is formed on the front surface of the transparent film substrate 2, and the second-direction electrode layer 4 is formed on the back surface.

Next, the third step of forming the transparent electrically conducting film electrode layer 6 on the back surface of the transparent film substrate 5 is performed. A transparent electrically conducting thin film made of ITO is deposited on one side of the transparent film substrate 5 with a sputtering apparatus by the roll-to-roll method. It is preferred to use a gas including an inert gas such as argon as the main component for the deposition. Then, patterning of an electrode pattern of the transparent electrically conducting film electrode layer 6 is performed by the photo lithography method.

With regard to patterning, a photoresist agent is applied on a surface of the transparent electrically conducting thin film, and then irradiated with (exposed to) ultraviolet light over a photomask having an electrode pattern of the transparent electrically conducting film electrode layer 6 formed thereon. The photoresist agent is then allowed to react to print the electrode pattern thereon. Then, the transparent electrically conducting thin film at portions which are not coated with the resist is removed by etching treatment. Finally the photoresist agent is removed with a chemical agent and the like. After the third step is completed, the second film member 1b is obtained in which the transparent electrically conducting film electrode layer 6 is formed on the back surface of the transparent film substrate 5.

As the last step, the fourth step of bonding the first film member 1a with the second film member 1b is performed. The first film member 1a is bonded with the second film member 1b using an optically transparent double-sided adhesive sheet as the transparent adhesive layer 7 to obtain the capacitive touch panel 1.

Here, the method of depositing the first-direction electrode layer 3, the second-direction electrode layer 4, and the transparent electrically conducting film electrode layer 6 is not limited to the sputtering method. Other deposition methods can appropriately be used as long as a uniform thin film can be formed.

Next, another embodiment of the layer structure of the capacitive touch panel 1 is described below. A capacitive touch panel 1A having a layer structure as shown in FIG. 8 may be obtained by forming the first-direction electrode layer 3, a transparent insulating layer 8, and the second-direction electrode layer 4 on the front surface (the first surface) of the transparent film substrate 2 in this order from the top, and forming the transparent electrically conducting film electrode layer 6 on the back surface (the second surface) thereof. Since the capacitive touch panel 1A can be formed with a single sheet of the transparent film substrate 2, it is made thinner as compared to the capacitive touch panel 1. In addition, in the capacitive touch panel 1A, the first-direction electrode layer 3 and the second-direction electrode layer 4 for contact operation are arranged above the transparent electrically conducting film electrode layer 6 as a layer structure. Therefore, a line of electric force from the transparent electrically conducting film electrode layer 6 is more likely to escape from the panel surface to the outside, enabling highly sensitive detection of non-contact operation.

FIG. 9 shows a capacitive touch panel 1B having a layer structure that may be obtained by forming the transparent electrically conducting film electrode layer 6 on the front surface (the first surface) of the transparent film substrate 2, and forming the first-direction electrode layer 3, the transparent insulating layer 8, and the second-direction electrode layer 4 on the front surface of the transparent electrically conducting film electrode layer 6 in this order from the top. Since the capacitive touch panel 1B can be formed with a single sheet of the transparent film substrate 2, it is made thinner as compared to the capacitive touch panel 1. In addition, in the capacitive touch panel 1B, the first-direction electrode layer 3 and the second-direction electrode layer 4 for contact operation are arranged above the transparent electrically conducting film electrode layer 6 as a layer structure. Therefore, a line of electric force from the transparent electrically conducting film electrode layer 6 is more likely to escape from the panel surface to the outside, enabling highly sensitive detection of non-contact operation. However, it requires a certain insulating layer or an electric control for separately detecting contact and non-contact, since the second-direction electrode layer 4 and the transparent electrically conducting film electrode layer 6 form different circuits.

FIG. 10 shows a capacitive touch panel 1C having a layer structure that may be obtained by bonding a first film member 1c with a second film member 1d through the transparent adhesive layer 7. The first film member 1c comprises by forming a first-direction electrode layer 3, the transparent insulating layer 8, and the second-direction electrode layer 4 on the front surface (the first surface) of the transparent film substrate 2 in this order from the top, and the second film member 41d comprises by forming the transparent electrically conducting film electrode layer 6 on the front surface (the first surface) of the transparent film substrate 5. The first film member 1c is arranged in a location closer to the panel surface of the capacitive touch panel 1C than the second film member 1d. Since the first-direction electrode layer 3, the transparent insulating layer 8, and the second-direction electrode layer 4 are sequentially deposited on the front surface of the transparent film substrate 2, after which patterning of each of the electrode layers 3, 4 is made simultaneously by the laser etching method and the like, it enables to shorten the production time and to reduce cost.

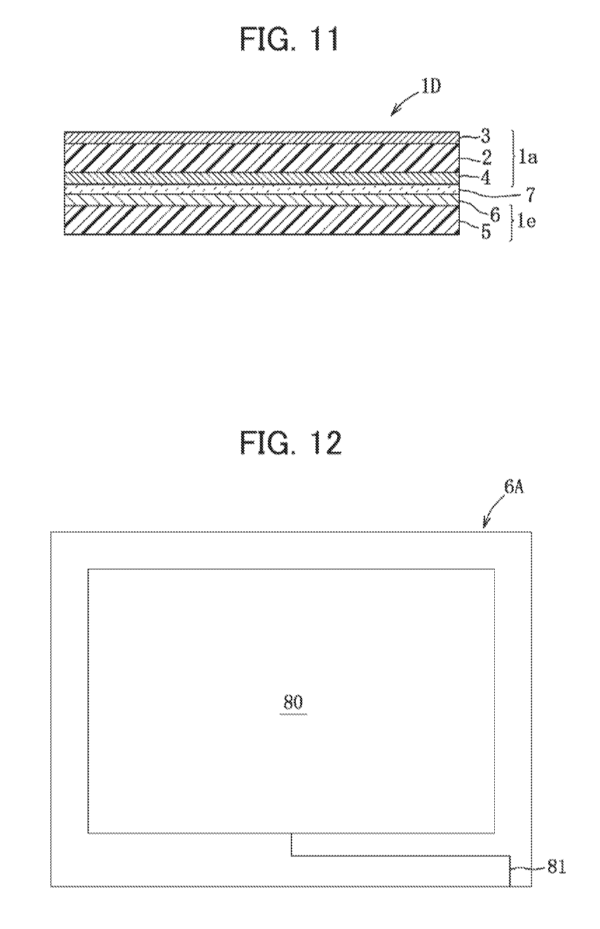

FIG. 11 shows a capacitive touch panel 1D having a layer structure that may be obtained by bonding a first film member 1a with a second film member 1e through a transparent adhesive layer 7, wherein: the first film member 1a is obtained by forming a first-direction electrode layer 3 on the front surface (the first surface) of the transparent film substrate 2, and forming the second-direction electrode layer 4 on the back surface (the second surface) thereof; and the second film member le is obtained by forming the transparent electrically conducting film electrode layer 6 on the front surface (the first surface) of the transparent film substrate 5. The first film member 1a is arranged at a location closer to the panel surface of the capacitive touch panel 1D than the second film member 1e. The capacitive touch panel 1D corresponds to the one where the second film member 1b of the capacitive touch panel 1 is replaced with the second film member 1e.

A layer structure of the capacitive touch panel 1 is not limited to those shown in FIGS. 7 to 11, and other layer structure can appropriately be selected as long as the first-direction electrode layer 3, the second-direction electrode layer 4, and the transparent electrically conducting film electrode layer 6 can be formed.

### Example 2

In Example 2, a transparent electrically conducting film electrode layer 6A is provided in place of the transparent electrically conducting film electrode layer 6 as shown in FIG. 12. Others are similar to the capacitive touch panel 1 from Example 1. The transparent electrically conducting film electrode layer 6A is configured such that one rectangular electrode segment 80 made of ITO is formed thereon, and a connection wire 81 is withdrawn from the electrode segment 80.

In the transparent electrically conducting film electrode layer 6A, since the area of the electrode segment 80 is large, the stray capacitance gets large when a fingertip is close to the panel surface. This enables highly sensitive detection of non-contact operation in which the fingertip approaches the panel surface from a direction perpendicular to the panel surface (the Z-axis direction). In the case of the transparent electrically conducting film electrode layer 6A for example, when a fingertip approaches the panel surface and the distance between the fingertip and the panel surface gets within a predetermined distance in the Z-axis direction, command may be provided, such as to display an operation menu on a display, to turn on a backlight which has been turned off to reduce power consumption.

### Example 3

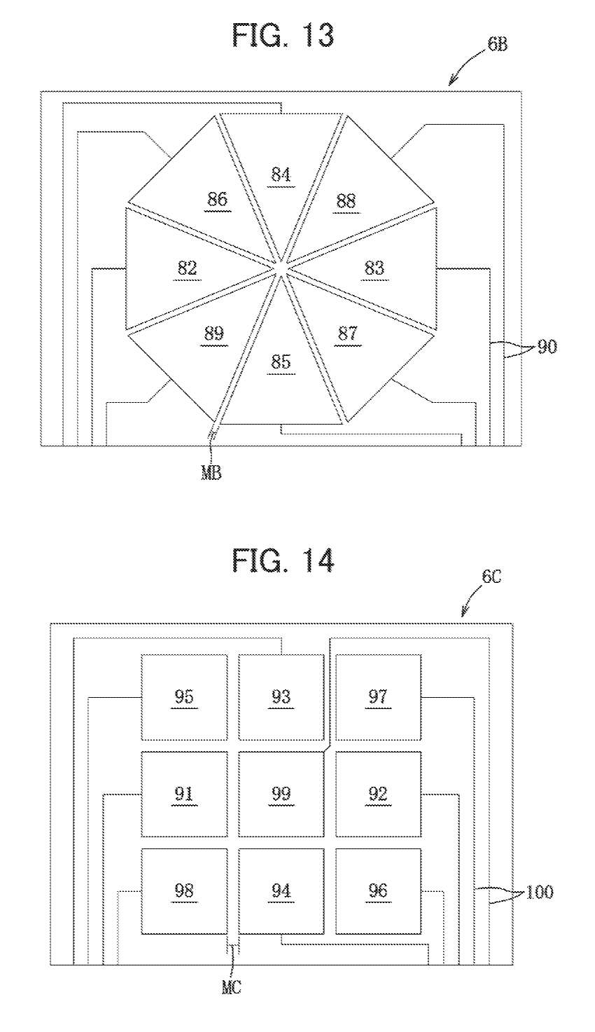

In Example 3, a transparent electrically conducting film electrode layer 6B is provided in place of the transparent electrically conducting film electrode layer 6 as shown in FIG. 13. Others are similar to the capacitive touch panel 1 from Example 1. The transparent electrically conducting film electrode layer 6B is configured as follows: a pair of electrode segments 82, 83 for detecting operation in the lateral direction are aligned along the lateral direction (the first direction); a pair of electrode segments 84, 85 for detecting operation in the longitudinal direction are aligned along the longitudinal direction (the second direction); a pair of electrode segments 86, 87 for detecting operation in a third direction (the third direction) that is rotated in the clockwise direction for 45° from the lateral direction (the first direction) are aligned along the third direction; a pair of electrode segments 88, 89 for detecting operation in a fourth direction (the fourth direction) that is rotated in the clockwise direction for 45° from the longitudinal direction (the second direction) are aligned along the fourth direction; all of which are arranged with an equally spaced gap MB provided between the electrode segments adjacent each other, having a connection wire 90 withdrawn from each of the electrode segments 82 to 89 respectively to be assembled in one side.

In addition to operation examples described in Example 1, the transparent electrically conducting film electrode layer 6B enables, for example, in a map displaying application for navigation and a game application, to direct a display position not only in the right to left or up and down directions (the electrode segments 82 to 85), but also in the upper right direction (the electrode segment 88), the lower right direction (the electrode segment 87), the upper left direction (the electrode segment 86), and the lower left direction (the electrode segment 89).

### Example 4

In Example 4, a transparent electrically conducting film electrode layer 6C is provided in place of the transparent electrically conducting film electrode layer 6 as shown in FIG. 14. Others are similar to the capacitive touch panel 1 from Example 1. The transparent electrically conducting film electrode layer 6C is configured as follows: a pair of electrode segments 91, 92 for detecting operation in the lateral direction are aligned along the lateral direction (the first direction); a pair of electrode segments 93, 94 for detecting operation in the longitudinal direction are aligned along the longitudinal direction (the second direction); a pair of electrode segments 95, 96 for detecting operation in a third direction (the third direction) that is rotated in the clockwise direction for 45° from the lateral direction (the first direction) are aligned along the third direction; and a pair of electrode segments 97, for detecting operation in a fourth direction (the fourth direction) that rotated in the clockwise direction for 45° from the longitudinal direction (the second direction) are aligned along the fourth direction; and an electrode segment 99 is arranged at the central location of the electrode segments 91 to 98; all of which are arranged with an equally spaced gap MC provided between the electrode segments adjacent each other, having a connection wire 100 withdrawn from each of the electrode segments 91 to 99 respectively to be assembled in one side.

In addition to operation examples described in Example 3, the transparent electrically conducting film electrode layer 6C enables, for example, to display an operation menu when a fingertip approaches the central electrode segment 99, and then to perform a specific command selected by moving the fingertip while it remains in the non-contact state. Further, it can be configured such that, when a fingertip approaches to either of the electrode segments 91 to 99 and the approach is detected, each of the numbers 1 to 9 may be first displayed on a position corresponding to the electrode segments 91 to 99, and then a pass code for canceling the sleep mode may be input by non-contact operation.

### Example 5

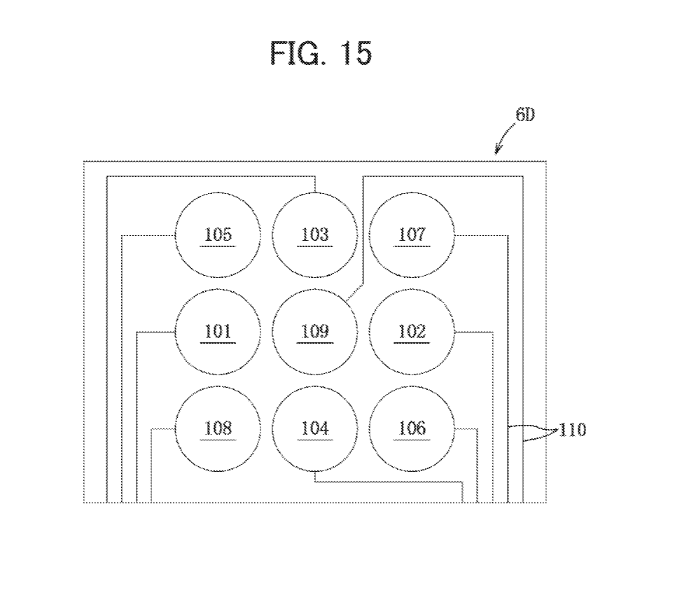

In Example 5, a transparent electrically conducting film electrode layer 6D is provided in place of the transparent electrically conducting film electrode layer 6 as shown in FIG. 15. Others are similar to the capacitive touch panel 1 from Example 1. The transparent electrically conducting film electrode layer 6D is configured such that each of the rectangular electrode segments 91 to 99 in the transparent electrically conducting film electrode layer 6C from Example 4 is replaced with circular electrode segments 101 to 109, having a connection wire 110 is withdrawn from each of the electrode segments 101 to 109 respectively to be assembled in one side. The transparent electrically conducting film electrode layer 6D enables the same operation examples as those described in Example 4.

In addition to these, a person skilled in the art can envision embodiments in which various modifications are added to the aforementioned Examples without departing the spirit of the present invention. The present invention shall encompass these alternative embodiments.

### EXPLANATION OF REFERENCE NUMERALS

1 Capacitive touch panel
1a First film member
1b Second film member
2, 5 Transparent film substrate
3 First-direction electrode layer
4 Second-direction electrode layer
6 Transparent electrically conducting film electrode layer
7 Transparent adhesive layer
30, 40 Electrically conducting fine wire
60 Capacitor element
61 to 64 Electrode segment
65 Connection wire
X First-direction electrode
Y Second-direction electrode

1. A capacitive touch panel, comprising:
one or more transparent film substrates;
multiple first-direction electrodes arranged on the film substrate and extending in a first direction; and
multiple second-direction electrodes arranged on the film substrate and extending in a second direction crosswise to the first direction,
wherein each of the first-direction electrodes and each of the second-direction electrodes comprises multiple fine wires made of an electrically conducting material, and
at least one transparent electrically conducting film electrode for detecting non-contact operation is provided.

2. The capacitive touch panel according to claim 1,
wherein the area of the transparent electrically conducting film electrode is larger than the total area of portions of the multiple first-direction electrodes and the multiple second-direction electrodes overlapping with the transparent electrically conducting film electrode from a top view.

3. The capacitive touch panel according to claim 1,
wherein the first- and second-direction electrodes are intended for detecting contact operation, and
the transparent electrically conducting film electrode comprises an electrically conducting material different from that of the first and second-direction electrodes.

4. The capacitive touch panel according to claim 1,
wherein the transparent electrically conducting film electrode comprises a metal oxide or an electrically conductive polymer material.

5. The capacitive touch panel according to a claim 1, which is configured to be capable of detecting non-contact operation of approaching a panel surface of the touch panel from a direction perpendicular to the panel surface, the non-contact operation being detected through the transparent electrically conducting film electrode.

6. The capacitive touch panel according to claim 1,
wherein the first direction is the lateral direction and the second direction is the longitudinal direction, and
the transparent electrically conducting film electrode comprises a pair of transparent electrically conducting film electrodes for detecting operation in the first direction aligned along the first direction, and a pair of transparent electrically conducting film electrodes for detecting operation in the second direction aligned along the second direction.

7. The capacitive touch panel according to claim 6,
wherein the transparent electrically conducting film electrode comprises a pair of transparent electrically conducting film electrodes for detecting operation in a third direction aligned along the third direction where the first direction is rotated in the clockwise direction for 45°, and a pair of transparent electrically conducting film electrodes for detecting operation in a fourth direction aligned along the fourth direction where the second direction is rotated in the clockwise direction for 45°.

8. The capacitive touch panel according to claim 1,
wherein the multiple first-direction electrodes and the multiple second-direction electrodes are formed on a first surface of the film substrate, and the transparent electrically conducting film electrode is formed on a second surface of the film substrate.

9. The capacitive touch panel according to claim 1,
wherein the transparent electrically conducting film electrode is formed on the first surface of the film substrate, and the multiple first-direction electrodes and the multiple second-direction electrodes having an insulating layer therebetween are formed on a surface of the transparent electrically conducting film electrode.

10. The capacitive touch panel according to claim 1, wherein a first film member is bonded with a second film member through an adhesive layer,
the first film member comprising two of the multiple first-direction electrodes, the multiple second-direction electrodes, and the transparent electrically conducting film electrode on a first film substrate,
the second film member comprising the remaining one of the multiple first-direction electrodes, the multiple second-direction electrodes, and the transparent electrically conducting film electrode on a second film substrate.

11. The capacitive touch panel according to claim 1, comprising
a first film member comprising the multiple first-direction electrodes on the first surface of the first film substrate and the multiple second-direction electrodes on the second surface of the first film substrate; and
a second film member comprising the transparent electrically conducting film electrode on a first surface and/or a second surface of the second film substrate,
wherein the first film member is arranged at a position closer to the panel surface than the second film member.
